(19) United States
(12) Patent Application Publication
(10) Pub. No.: US 2023/0064973 A1
(43) Pub. Date: Mar. 2, 2023

(54) ARTIFICIAL INTELLIGENCE AND SWARM INTELLIGENCE METHOD AND SYSTEM IN SIMULATED ENVIRONMENTS FOR AUTONOMOUS DRONES AND ROBOTS FOR SUPPRESSION OF FOREST FIRES

(71) Applicant: André Augusto CEBALLOS MELO, São Paulo (BR)

(72) Inventor: André Augusto CEBALLOS MELO, São Paulo (BR)

(21) Appl. No.: 17/737,269

(22) Filed: May 5, 2022

(30) Foreign Application Priority Data
Aug. 26, 2021 (BR) 10 2021 016894 3

(51) Int. Cl. A62C 3/02; A62C 99/00; G05D 1/10; G05D 1/00; B64D 1/16; B64C 39/02

(52) U.S. Cl. CPC A62C 3/0228; A62C 99/0081; G05D 1/104; G05D 1/0088; B64D 1/16; B64C 39/024; B64C 2201/127; B64C 2201/143

(57) ABSTRACT

A new artificial intelligence and swarm intelligence method and system in simulated environments for autonomous drones and robots for suppression of forest fires, which foresees the simulation of swarm intelligence models in simulated environment for autonomous drones and robots for suppression of forest fires, performing the analysis of forest fires based on data and information on real time conditions or historical data, of a burning area, transforming same into a simulation environment to obtain a better strategy for firefighting, based on virtual reality environments for digital land, with a mixture of real and virtual images, using satellite/aerial images and combined maps of virtual reality, augmented and mixed. Thus, providing improvements and higher efficacy in combatting forest fires.

### FIELD

This invention refers to a new artificial intelligence and swarm intelligence method and system in simulated environments for autonomous drones and robots for suppression of forest fires, which foresees the simulation of swarm intelligence models in simulated environment for autonomous drones and robots for suppression of forest fires, performing the analysis of forest fires based on data and information on real time conditions or historical data, of a burning area, transforming same into a simulation environment to obtain a better strategy for firefighting, based on virtual reality environments for digital land, with a mixture of real and virtual images, using satellite/aerial images and virtual reality combined maps, augmented and mixed. Thus, providing improvements and higher efficacy in combatting forest fires.

The artificial intelligence and swarm intelligence method and system in simulated environments for autonomous drones and robots for suppression of forest fires, object of the present invention, is a new tool in the platform of research and development of autonomous technology for suppression of forest fires.

The artificial intelligence and swarm intelligence method and system in simulated environments for autonomous drones and robots for suppression of forest fires, object of the present invention, has the purpose of presenting a new tool as a research and development platform for autonomous technology of suppression of forest fires, with environment built on virtual reality or augmented reality, using data from real or customized world maps, to simulate a fire dispersion using an algorithm which also calculates atmospheric effects, helping to prospect and prevent forest fires.

### BACKGROUND

Forest fires are destructive forces; however, they can occur naturally. For this reason, certain plants and animals evolved to depend on periodical forest fires for the ecological balance. It may seem counter intuitive that a fire, which burns plants and places animals in danger within an ecosystem, can promote ecological health. However, fire is a natural phenomenon and nature has evolved with its presence.

The climatic change induced by man promotes the conditions on which the forest fires depend, increasing their probability of occurrence. According to a research review about global climatic change there is always a risk of forest fires. At the end, the truth is that the burden of preventing uncontrolled fires falls on humanity.

The fire age is upon us, the climatic changes are subverting the system.

The fires of this new era cannot always be tamed. Neither the aircraft nor the ground teams can do much about the flames which spread quickly with powerful winds. This forced the firefighting to “be a global effort, not a state or national effort”. It is time to rethink the neighbor resource sharing system.

Thus, the artificial intelligence and swarm intelligence method and system in simulated environments for autonomous drones and robots for suppression of forest fires, object of the present invention, does not intend to compete with the firefighters, but to be a complementary tool.

Since the drones can fly by day or by night and obtain quick access to urban or rural fires which before were inaccessible, they can help to save the life of the public as well as with first aid. The use of intelligent robots to explore the area and pour water or fire deterrent can enable humans to remain much farther away from the danger zone, just looking at the data of the drones to reach conclusions in the safety of a command-and-control center.

The automation in firefighting is inevitable. It is only a matter of time until the technology will have the potential to alleviate the challenges that people face every day. Just as the trans-frontier cooperation is a key element to be considered, locating, and identifying opportunities, developing the projects for installation and operation of the micro networks, which make life easier.

There exist some patent documents which describe methods, process, and equipment, for combatting, monitoring and prevention of forest and urban fires, however, none of these documents predicts the configuration and working of the method and system herein proposed. Among these documents we can highlight the following:

Patent document PI 9104953-9, PROCESS AND DEVICES FOR COMBATTING FOREST FIRES, which refers to an original process for combatting forest fires, using aircraft which pass through the fires or fire lines, bombing with water or chemical products, at a low height in the longitudinal direction of the fire line, above the vegetation, until a non-propagating, non-combustible wet strip is formed, creating a natural barrier to the fire, allowing the control and extinction thereof. In general lines, the invention comprises aircraft having a container (1), foreseeing a ventral casing or complement (2), sprinkler or valve (3), being foreseen a drive set (4);

Patent document PI 0707053-5, INERTING PROCESS FOR REDUCING RISK AND EXTINGUISHING FIRES IN A PROTECTED AREA, wherein the invention refers to an inerting process for decreasing a risk of fire and for extinguishing fires in a protected space, wherein an oxygen concentration in the protected space is first reduced to a specific base inerting level, and wherein the oxygen concentration in the protected space is maintained at the base inerting level, to enable that in the protected space it is no longer necessary to alleviate pressure or that the pressure alleviation is necessary only at a minimum threshold for the use of the inerting process and to enable at the same time that in case of fire, the firefighting may be carried out by the introduction of additional inert gases due to the extension of the fire inside the protected area, is foreseen, according to the invention, where, in case of fire within the protected area the percentage of oxygen is even further reduced, leaving the basic inerting level to a first reduced level, that the oxygen percentage is continuously maintained at the first reduced level during a first predetermined period, and that the oxygen percentage is even more reduced, leaving the first reduced level to a total inerting level, in case the fire has still not been extinguished after the first predetermined period has elapsed;

Patent document PI 0305862-0, PROCESS FOR DISSIPATING FLAMES IN FIELD FIRES AND RESULTANT EQUIPMENT. This patent of invention refers to a process for dissipating flames in field fires by using atmospheric air at a large flow rate to dissipate the combustion element of the heated vegetation and in this manner interrupt the propagation cycle and smother the flames, directing the strong aeolic flow of the same against the ashes, extinguishing the fire. The process uses improved equipment for spraying over individual orchards/plantations having rear, side or wheel fixation in the form of carts or adapted to vehicles, eliminating the disadvantages of the current processes and equipment, since it presents greater autonomy in combating field fires, depending solely on the fuel or electric power to activate the sprayer, providing higher output and efficiency, less weight for the firefighter or combatant, less physical effort, having, therefore, significantly improved cost-benefit relation;

Patent document PI 102018016857-6, COMPUTER-IMPLEMENTED METHOD, which describes a method including controlling an unmanned aerial vehicle to fly over a forestry worksite and capture imagery information with an image capture component. The imagery information is used to generate a set of ground disturbance metrics, each having a value indicative of a measure of ground disturbance at a different geographic location in the forestry worksite. Alternatively, the imagery information is used to generate a set of slope metrics or a firefighting metric. According to the ground disturbance, slope, and firefighting metrics, the method is used to generate an action signal, such as an action signal that controls movement of a mobile machine operating at the forestry worksite, among others;

Patent document PI 0415154-2, SYSTEMS AND METHODS FOR AERIAL DISPERSION OF MATERIALS, wherein the object of the invention is a system which can be employed to allow quick and temporary conversion of the aircraft for the purposes of aerial dispersion, such as aerial firefighting. The aerial dispersion systems can be implemented using modular components which can be configured for compatibility with conventional loading and unloading of modern aircraft, including the lateral loading system of large aircraft and with high lifting capacity. The aerial dispersion systems can be quickly installed in a large squadron of aircraft with quick response capacity in case of fire or other emergency which develops rapidly, such as an oil spillage, chemical or biological contamination incident, fire in building or refinery etc. After use, the squadron aircraft can be quickly dismantled and returned to the original condition. The aerial dispersion systems can be operated by a squadron of aircraft in a coordinated manner, for example, as part of the formation for firefighting with multiple sharing of information and/or common control of the aircraft;

Patent document PI 0011191-0, METHODS FOR SEISMIC EXPLORATION, FOR FIREFIGHTING WITH A SPECIFIC TARGET, WITH QUICK DISTRIBUTION OF MATTER OR OBJECTS TO A REMOTE POSITION BASED ON THE USE OF PROJECTILE LAUNCHING MECHANISM, wherein the launching mechanism counts on a set of pipes (10), each one including a series of projectiles (11) combined in line within the pipe (12) and associated with the selectively discontinuous flammable propellant charges (13) to propel the projectiles (11) through the pipe mouth (12). The projectiles (11) are designed for civil or non-military purposes and include the retention body (17) wherein the matter or objects can be transported. The projectiles (11) are combined with one another and with the pipe (12) in such a manner that they prevent the subsequent path of an inflamed charge to the load propulsor vessel. The matter or the objects within the retention body (17) can include explosive charges for seismic exploration, fire retardants, fire extinguishing devices, pyrotechnics, herbicides, pesticides, fertilizer or seeds, the distribution methods for the loaded projectiles (11) for the civilian purposes are claimed;

Patent document PI 0211236-1, FIREFIGHTING APPARATUS AND FIREFIGHTING METHOD, wherein the invention refers to a firefighting apparatus (20) for combatting a fire (10) having a relatively large area or volume (11, 12) said apparatus including a system of aiming at a target (23) for identification of a target area to be sprayed with a fire retardant and a cannon (21) for unloading a multiplicity of projectiles (22) containing the fire retardant (32). The cannon of the apparatus includes at least one pipe barrel set (30), said at least one pipe barrel set having a barrel (39), a plurality of projectiles (35) axially disposed within the pipe for operational sealing engagement with the barrel core (39), and discrete propulsion loads (36) to propel the respective projectiles sequentially through the pipe mouth, whereby the fire retardant is dispersed over the target area or within the target volume;

Patent document PI 9709954-6, METHOD AND APPARATUS FOR LOCATING AND/OR EXTINGUISHING FIRES, which refers to a method for locating and/or extinguishing fires, primarily designed to efficiently combat intensive fires and in large scale which occur in almost inaccessible places. It consists in the direct combined action over a fire zone of a finely dispersed air cloud (4) of a firefighting composition, a shock air wave (5) and an air velocity pressure height and detonating products which are formed as a consequence of the explosion of a dispersion load from a firefighting apparatus (1), when the latter comes close to a combustion zone. The fire suppression apparatus (1), which executes the proposed method, is produced in the form of a flask of ecologically clean material, which is filled with a firefighting composition, comprises a dispersion load and a selected parameter sensor, for example, height, adjusted to a pre-determined parameter value (height) to be reached, when the firefighting apparatus (1) gets close to the combustion zone, there occurs an explosion of dispersion load in a pre-determined area of the fire, whereby the dimensions and location of the fire suppression areas are selected considering the type of fire and the dimensions of the finely dispersed air cloud (4) formed by the firefighting composition; and

Patent document PI 112021007431-7, HIGH-EFFICIENCY METHOD USING UNMANNED AERIAL VEHICLES FOR FIREFIGHTING, which refers to a method of firefighting based on unmanned aerial vehicles “UAV(s)” launched from transporter aircrafts to deliver water or fire-retardants or any other firefighting materials to a location selected by the firefighting personnel. A capability of putting-off high intensity forest fires is provided, that stems from the precision and the quantity of material that can be delivered per unit surface per unit time. After releasing the firefighting material(s), the UAV reaches a safe altitude from which it flies on autopilot to intercept and then proceed on a pre-programmed route to land per pre-programmed instructions on an airfield from which firefighting transporter(s) operate, allowing a high efficiency along the line, from loading the transporter airplanes to maximizing the quantity of material that reach the target, to minimizing the remote-pilot time and up to the recovery system that minimizes the recovery cost and it maximizes UAVs' utilization by a quick turnaround.

### SUMMARY

This invention refers to a new artificial intelligence and swarm intelligence method and system in simulated environments for autonomous drones and robots for suppression of forest fires, which foresees the simulation of swarm intelligence models in simulated environment for autonomous drones and robots for suppression of forest fires, performing the analysis of forest fires based on data and information on real time conditions or historical data, of a burning area, transforming same into a simulation environment to obtain a better strategy for firefighting, based on virtual reality environments for digital land, with a mixture of real and virtual images, using satellite/aerial images and virtual reality combined maps, augmented and mixed. Thus, providing improvements and higher efficacy in combatting forest fires.

The artificial intelligence and swarm intelligence method and system in simulated environments for autonomous drones and robots for suppression of forest fires, object of the present invention, is a new tool in the platform of research and development of autonomous technology for suppression of forest fires.

### DETAILED DESCRIPTION

The artificial intelligence and swarm intelligence method and system in simulated environments for autonomous drones and robots for suppression of forest fires, object of the present invention is a new tool of a research and development platform for autonomous technology of suppression to forest fires, which predicts the simulation of swarm intelligence models in simulated environment for autonomous drones and autonomous robots for suppression of forest fires, performing the analysis of forest fires based on data, and information on real time conditions or historical data, of a burning area, transforming same into a simulation environment to obtain a better firefighting strategy, based on virtual reality environment for the digital land, with a mixture of real and virtual images, using satellite/aerial images and virtual reality combined maps augmented, and mixed, in an environment constructed with virtual reality and augmented reality, using map data from the real world or customized to simulate the fire dispersion using an algorithm that also calculates atmospheric effects, helping to prospect and combat forest fires.

The method uses technology from new channels and tools for interdisciplinary conduction such as: The Internet of Things (IoT), Swarm intelligence (SI), Automaton Quadruped Robotics and UAVs (unmanned aerial vehicles) in an environment simulated by computer, predicting tendencies and creating strategies to transform data in actionable insights.

The method uses computer models using data, mathematics, and computer instructions to predict events in the real world. Covering techniques and methods for firefighting management, considering the heterogeneity and specific and local variabilities of the location.

The artificial intelligence and swarm intelligence method and system in simulated environments for autonomous drones and robots for suppression of forest fires, object of the present invention, comprises several drones and robots such as quadrupeds with image processors, at least one processing unit with a software to simulate the fire dispersion and the progress of the fire using an algorithm, which also calculates atmospheric effects; at least one functional interactive interface which the administrator will use to control the velocity of the wind, direction of the wind and similar physical and environmental elements with simulation configuration.

The system presents an economic configuration that is easily reproducible with open code tools in conformity with the commercially available technology, current specifications, standards, and regulatory orientations.

Therefore, the artificial intelligence and swarm intelligence method and system in simulated environments for autonomous drones and robots for suppression of forest fires, object of the present invention presents a new precise firefighting concept for the management of fires on specific locations. As a “management strategy” that uses the information technology to bring data from several sources to support the decisions associated to firefighting. By means of a model of the product, which gives an idea of the design, navigation, and layout, providing the analysis of forest fires based on data (information about real time conditions or historical data) of a burning area, transform it into a simulation environment and obtain the best strategy in firefighting, generating virtual environments based on reality for the digital land (mixture of real and virtual images), using satellite/aerial images and virtual reality, combined maps, augmented, and mixed to be able to simulate the dispersion of a forest, chemical and aerosol formation fire, using AI to control several drones and robots such as the quadruped robots.

In this manner, the method and system, objects of the present invention, have great advantages, since they provide a structure essentially based on rules for decision-making. In general, in conformity with the technology, specifications, standards and current regulatory orientations commercially available. Being constructed for error-prone environments in the real world, informing the necessary human decision-making, contributing to new efforts without interrupting the current and future firefighting forces, enabling the planning of smart action, smartly routing the correct alerts for swarm robot operations with customized alerts activated or released in specific strictness levels to help in the strategic planning, working in trans-frontier cooperation in micro networks with analysis of time and the propagation of the alert which reduces the time of the fire alerts from hours to seconds, thus providing a great preciseness to firefighting.

Thus, by the configuration and characteristics and working, described above, it can be clearly seen that the ARTIFICIAL INTELLIGENCE AND SWARM INTELLIGENCE METHOD AND SYSTEM IN SIMULATED ENVIRONMENTS FOR AUTONOMOUS DRONES AND ROBOTS FOR SUPPRESSION OF FOREST FIRES, object of the present invention, refers to a method and new devices for the State of the Art which comprises the unpublished novelty, inventive activity and industrial application which makes them deserve the Patent of Invention Privilege.

1. A method of artificial intelligence and swarm intelligence in simulated environments for autonomous drones and robots for suppression of forest fires, comprising: autonomous technology of suppression to forest fires, which predicts the simulation of swarm intelligence models in a simulated environment for autonomous drones and autonomous robots for suppression of forest fires, performing the analysis of forest fires based on data, and information about real time conditions or historical data, of a burning area, transforming it into a simulation environment to obtain a better firefighting strategy, based on virtual reality environment for the digital land, with a mixture of real and virtual images, using satellite/aerial images and virtual reality, combined maps, augmented and mixed, in an environment constructed with virtual reality and augmented reality, using map data from the real world or customized to simulate the fire dispersion using an algorithm that also calculates atmospheric effects, helping to prospect and combat forest fires.

2. The method according to claim 1, wherein said method uses at least one of: The Internet of Things (IoT), Swarm intelligence (SI), Automaton Quadruped Robotics and UAVs (unmanned aerial vehicles) in an environment simulated by computer, predicting tendencies and creating strategies to transform data in actionable insights.

3. The method according to claim 1, wherein said method uses computer models using data, mathematics, and computer instructions to predict events in the real world, covering techniques and methods for firefighting management, considering the heterogeneity and specific and local variabilities of the location.

4. A system for artificial intelligence and swarm intelligence in simulated environments for autonomous drones and robots for suppression of forest fires, the system comprising: several drones and robots with image processors, at least one processing unit with a software to simulate the fire dispersion and the progress of the fire using an algorithm, which also calculates atmospheric effects; at least one functional interactive interface which an administrator will use to control the velocity of the wind, direction of the wind and physical and environmental elements with simulation configuration; said system presenting an economic configuration and easily reproducible such as open code tools in conformity with the commercially available technology, specifications, standards and current regulatory orientations.
